(19) United States
(12) Patent Application Publication
(10) Pub. No.: US 2024/0354130 A1
(43) Pub. Date: Oct. 24, 2024

(54) CONTEXTUAL ARTIFICIAL INTELLIGENCE (AI) BASED WRITING ASSISTANCE

(71) Applicant: Microsoft Technology Licensing, LLC, Redmond, WA (US)

(72) Inventors: Enrico CADONI, Dublin (IE); James COGLEY, Dublin (IE); Aman SINGH, Dublin (IE)

(73) Assignee: Microsoft Technology Licensing, LLC, Redmond, WA (US)

(21) Appl. No.: 18/304,542

(22) Filed: Apr. 21, 2023

(51) Int. Cl. G06F 9/451; G06F 3/0482; G06F 40/166; G06F 40/279

(52) U.S. Cl. CPC G06F 9/453; G06F 3/0482; G06F 40/166; G06F 40/279

(57) ABSTRACT

Systems and methods for generating artificial intelligence (AI) writing assistance include receiving a writing prompt to be used by an AI writing engine from a writing assistance client. The writing prompt is processed to provide indication of relevant user content items that can be referenced in the writing prompt. The content and metadata for any content items referenced in the writing prompts is retrieved and aggregated with the writing prompt to generate a request for writing assistance for the AI writing engine. Once writing feedback is received, the feedback is provided to the writing assistance wherein it can be displayed in the UI for acceptance by a user.

### BACKGROUND

Effective communication is a critical component of success in any cooperative organization, effort or enterprise. Within the realm of communication, written communication is often needed or preferred in situations when verbal communication may be less efficient or convenient. However, effective written communication can be a challenge. The aptitude for producing effective writing can vary dramatically between different people. Additionally, some writers may need to communicate in a written language that is not their native language. Such writers may not be aware of accepted conventions in the language in which they are writing and, therefore, may not be able to identify errors.

Consequently, writing assistance tools can be a very useful component in the writing process. Currently, artificial intelligence (AI) based writing assistance is helping millions of users to write better documents. Examples of such AI-based writing assistance tools include generative models, such as GPT-4 and ChatGPT. GPT stands for “Generative Pre-trained Transformer.” It is a type of large-scale neural language model developed by OpenAI that uses deep learning techniques to generate natural language text. GPT models are pre-trained on large datasets of text, allowing them to learn patterns and relationships in language and then generate new text based on that learning. GPT models have been trained on a wide range of text, from web pages to books, and can be fine-tuned for specific tasks, such as question answering, summarization, and translation. They have been used in a variety of applications, including chatbots, language translation, and text generation for creative writing and content creation. ChatGPT, on the other hand, is a variant of GPT that has been specifically fine-tuned for conversational tasks, such as chatbots and dialogue systems. ChatGPT has been trained on a large corpus of conversational data and can generate responses to user input in a way that simulates natural conversation.

While AI-based writing assistant tools are effective in helping a user write documents, reports, email messages, and the like, these tools have limitations due to their short-term memory and the general, not contextual, knowledge they have been built with. In addition, AI-based writing tools, and AI models in general, are more prone to hallucinations (i.e., unanticipated results) without grounded context. Hence, what is needed are AI-based writing assistance tools that are capable of contextualizing the AI model response.

### SUMMARY

In one general aspect, the instant disclosure presents a data processing system having a processor and a memory in communication with the processor wherein the memory stores executable instructions that, when executed by the processor, cause the data processing system to perform multiple functions. The functions include receiving user input from a user interface (UI) component of a writing assistance client, the user input defining a writing prompt to be used by an artificial intelligence (AI) writing engine as a basis for generating writing feedback; as the user input is being received, identifying user content items relevant to the writing prompt based on the user input; providing indication of the identified user content items to the writing assistance client; receiving indication of selection of at least one user content item that is to be referenced in the writing prompt; retrieving content and metadata pertaining to each selected user content item from a context data collection; monitoring the user input for a sequence termination character; in response to detecting the sequence termination character, aggregating the writing prompt, the content, and the metadata to generate a request for writing assistance that is supplied to the AI writing engine; receiving the writing feedback from the AI writing engine; and providing the writing feedback to the writing assistance client.

In yet another general aspect, the instant disclosure presents a method for generating writing assistance from an AI writing engine. The method includes receiving user input from a user interface (UI) component of a writing assistance client, the user input defining a writing prompt to be used by an artificial intelligence (AI) writing engine as a basis for generating writing feedback; as the user input is being received, identifying user content items relevant to the writing prompt based on the user input; providing indication of the identified user content items to the writing assistance client; receiving indication of selection of one or more content items that are to be referenced in the writing prompt; retrieving content and metadata pertaining to the one or more content items from a context data collection; aggregating the writing prompt, the content, and the metadata to generate a request for writing assistance that is supplied to the AI writing engine; receiving the writing feedback from the AI writing engine; and providing the writing feedback to the writing assistance client.

In a further general aspect, the instant application describes a non-transitory computer readable medium on which are stored instructions that when executed cause a programmable device to perform functions of receiving a writing prompt to be used by an artificial intelligence (AI) writing engine as a basis for generating writing feedback from a user interface (UI) component of a writing assistance client; as the writing prompt is being received, identifying user content items relevant to the writing prompt based on text of the writing prompt; providing indication of the identified user content items to the writing assistance client; receiving indication of selection of one or more content items that are to be referenced in the writing prompt; in response to receiving the indication, retrieving content and metadata pertaining to the one or more content items from a context data collection and storing the content and the metadata in a user context holder, monitoring the writing prompt for a sequence termination character; in response to detecting the sequence termination character, retrieving the content and the metadata from the user context holder, and aggregating the writing prompt, the content and the metadata to generate a request for writing assistance for the AI writing engine; receiving the writing feedback from the AI writing engine; and providing the writing feedback to the writing assistance client.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 depicts an example implementation of a writing assistance system which may be implemented in the system of FIG. 1.

FIG. 3A depicts an example implementation of a UI component of a writing assistance client of the system of FIG. 2.

FIG. 3B depicts an example implementation of the UI component of FIG. 3A showing a feedback result.

FIG. 4 depicts an example implementation of an AI writing engine for a writing assistance system, such as the writing assistance system of FIG. 2.

FIG. 5 depicts a flow diagram of an example method 500 for generating writing assistance from an AI writing engine.

FIG. 6 is a block diagram illustrating an example software architecture, various portions of which may be used in conjunction with various hardware architectures herein described.

FIG. 7 is a block diagram illustrating components of an example machine configured to read instructions from a machine-readable medium and perform any of the features described herein.

### DETAILED DESCRIPTION

Currently, artificial intelligence (AI) based writing assistance tools are helping millions of users to write better documents. Such tools can produce fairly high-quality content in many different areas, from short stories, to essays, to entire scientific papers, with varying degrees of success and veracity. However, these tools are generally not capable of remembering or considering contextual information pertaining users requesting assistance or the prompts for which assistance is created. As a result, previously known AI-based writing assistance tools are generally not capable of shaping, contextualizing, and making writing assistance feedback more human.

To address these technical problems and more, in an example, this description provides technical solutions in the form of an AI-based writing assistance tool that provides improved writing feedback with a contextualized response from a large language model (LLM) using detailed and refined context data that is aggregated and sent to the model. An LLM is a deep learning algorithm that can recognize, summarize, translate, predict and/or generate text and other content based on knowledge gained from massive datasets. Examples of LLMs include, but are not limited to, generative models, such as Generative Pre-trained Transformer (GPT)-based models. e.g., GPT-3, GPT-4, ChatCPT, and the like. Context data pertaining to user interactions with applications and documents, as well as specific information related to a user, such as project files, project names, acronyms, and the like, is collected and used to facilitate the entry of writing prompts and to augment calls for writing assistance from the LLM.

The solutions include a user interface (UI) that facilitates the entry of writing prompts used as the basis for requesting writing assistance from the LLM. As a user enters text of a writing prompt, content items, such as documents, emails, messages, and the like, are identified and either offered to the user for referencing in the writing prompt or simply incorporated into the writing prompt without the need for user intervention. Metadata pertaining to each content item selected by a user to reference in a writing prompt is retrieved and stored until the entire writing prompt has been entered. A sequence termination character (such as the TAB key) is used to indicate when entry has been completed. Once the sequence termination character has been entered, the writing prompt, the content of any referenced files, and the metadata for the reference files is aggregated to generate a request for writing assistance from the LLM. The feedback result is then rendered in the UI which provides the user the options of accepting the feedback result, deleting the feedback result, or trying again.

The technical solutions described herein address the technical problem of inefficiencies and difficulties associated AI-based writing assistance. The technical solutions facilitate the generation of writing prompts that includes contextual content and metadata pertaining to the content that enables writing prompts to be constructed in a manner that contextualizes the responses produced by the LLM without having to extend the functionality of the LLM or having the model store and utilize context data or complex state information. The technical effects of the solutions include improving the efficiency of generating writing prompts for AI models and improving the effectiveness of AI-based writing assistance.

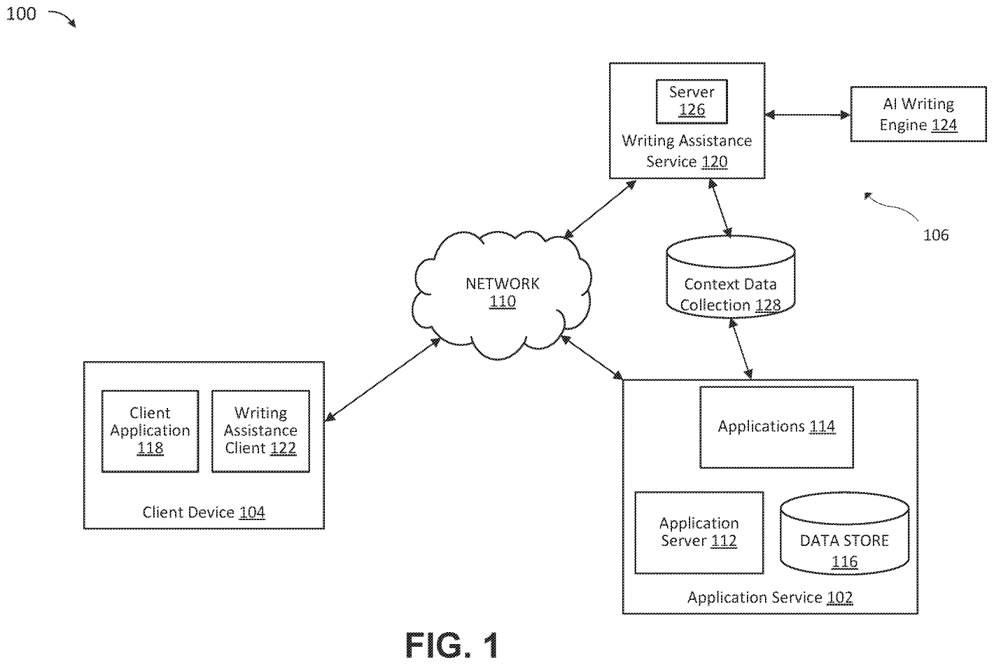

FIG. 1 shows an example computing environment 100 for providing writing assistance services to users. Computing environment 100 includes an application service 102, a client device 104, a writing assistance system 106, and an AI writing engine 108 which communicate with each other via a network 110. The network 106 includes one or more wired, wireless, and/or a combination of wired and wireless networks. In embodiments, the network 106 includes one or more local area networks (LAN), wide area networks (WAN) (e.g., the Internet), public networks, private networks, virtual networks, mesh networks, peer-to-peer networks, and/or other interconnected data paths across which multiple devices may communicate. In embodiments, the network 106 is coupled to or includes portions of a telecommunications network for sending data in a variety of different communication protocols. In some implementations, the network 106 includes Bluetooth® communication networks or a cellular communications network for sending and receiving data including via short messaging service (SMS), multimedia messaging service (MMS), hypertext transfer protocol (HTTP), direct data connection, WAP, email, and the like.

The application service 102 is implemented as a cloud-based service or set of services. To this end, application service 102 includes at least one application server 112 which is configured to provide computational and/or storage resources for implementing the application service 102. The application server 112 is representative of any physical or virtual computing system, device, or collection thereof, such as, a web server, rack server, blade server, virtual machine server, or tower server, as well as any other type of computing system. In embodiments, the application server is implemented in a data center, a virtual data center, or some other suitable facility. Application server 112 executes one or more software applications, modules, components, or collection thereof capable of providing the application service to clients, such as client device. In embodiments, the application service 40 provides one more web-based content editing applications 114 which provide functionality for users to consume, create, share, collaborate on, and/or modify various types of electronic content, such as but not limited to textual content, imagery, presentation content, web-based content, forms and/or other structured electronic content, and other types of electronic content. In embodiments, application server 112 hosts data and/or content in connection with the application service 102 and makes this data and/or content available to the users of client devices 104 via the network 106. Program code, instructions, user data and/or content for the application service is stored in a data store 116. Although a single server 112 and data store 116 are shown in FIG. 1, application service 102 may utilize any suitable number of servers and/or data stores.

Client device 104 enables users to access services and/or applications offered by application service. Clients 104 comprise any suitable type of computing device, such as personal computers, desktop computers, laptop computers, mobile telephones, smart phones, tablets, phablets, smart watches, wearable computers, gaming devices/computers, televisions, and the like. Each client device 104 includes at least one client application 118 that is executed on the client device 104 for interacting with the application service 102. In embodiments, the client application 118 is a local content editing application, such as a word processor, spreadsheet application, presentation authoring application, email client, and/or the like, that is capable of communicating and interact with application service. In other embodiments, the client application 118 is a web browser that enables access to web-based application(s) implemented by the application service.

Writing assistance system 106 is configured to provide AI-generated writing feedback to users of content editing applications, such as client application 118. The writing assistance system 106 includes a writing assistance service 120, a writing assistance client 122, and an AI writing engine 124. Writing assistance service 120 includes at least one server 126 which provides computational and/or storage resources for implementing the writing assistance service 102. The writing assistance service receives writing prompts for which users are requesting writing assistance. A writing prompt consists of one sentence or short paragraph that indicates a topic and/or a question for which writing feedback is requested. The writing prompt is entered as a text string. The text string is received by the writing assistance service and processed to identify relevant content items from the user's context data to offer to the user to reference in the writing prompt. User context data is stored in context data collection 128. User context data identifies content items, such as files, emails, messages, web pages, and the like, which the user has previously authored, received, and/or viewed. The user context data includes metadata pertaining to the user's interaction with the content items, such as applications used, items accessed, number of times items have been accessed, length of time interacting with items, and the like, as well as other information pertaining to the items, such as project names associated with the items, tags or key words associated with the items, etc. In embodiments, user context data is collected over time and stored in the context data collection 128 by one or both of the application service 102 and the writing assistance service 120.

The writing assistance service 120 is configured to retrieve the content and metadata associated with each content item referenced in a writing prompt. In embodiments, content from a content item is retrieved from a data store, such as data store 116. Metadata from the content items can be retrieved from the context data collection or from the data store 116. The writing assistance service 120 is configured to aggregate the writing prompt, content of selected content items, and metadata of selected content items to generate a request for writing feedback from the AI writing engine 124. In embodiments, the AI writing engine 124 communicates with an LLM which has been trained on vast quantities of text data to produce human-like responses to dialogue or other natural language inputs. The LLM receives the writing prompt, content of selected content items, and metadata as input and produces writing feedback. In embodiments, writing feedback may include combining information from two or more documents into one coherent writing sample, analyzing content to identify key points, summarizing content, and the like.

Client device 104 includes a writing assistance client 122 for accessing functionality provided by the writing assistance service 120. The writing assistance client 122 comprises a software application, module, component, or collection thereof capable of interacting with the writing assistance service 120 (explained in more detail below). In one embodiment, the writing assistance client 122 is implemented as an integrated feature or component of a content editing application, such as a plug-in or add-in for a local content editing application on the client device. In other embodiments, the writing assistance client 122 is implemented as a standalone software application programmed to communicate and interact with the writing assistance service.

The writing assistance client 122 provides a user interface (UI) for receiving the text input for the writing prompt. The writing prompt is entered as a text string into the UI. As noted above, the text string is received by the writing assistance service and processed to identify relevant content items from the user's context data to offer to the user to reference in the writing prompt. The writing assistance client 122 receives selections of relevant content items which are also communicated to the writing assistance service. The writing assistance client 122 communicates the finished writing prompt, including references to relevant content items (if any), to the writing assistance service 120 to request writing feedback, as described above.

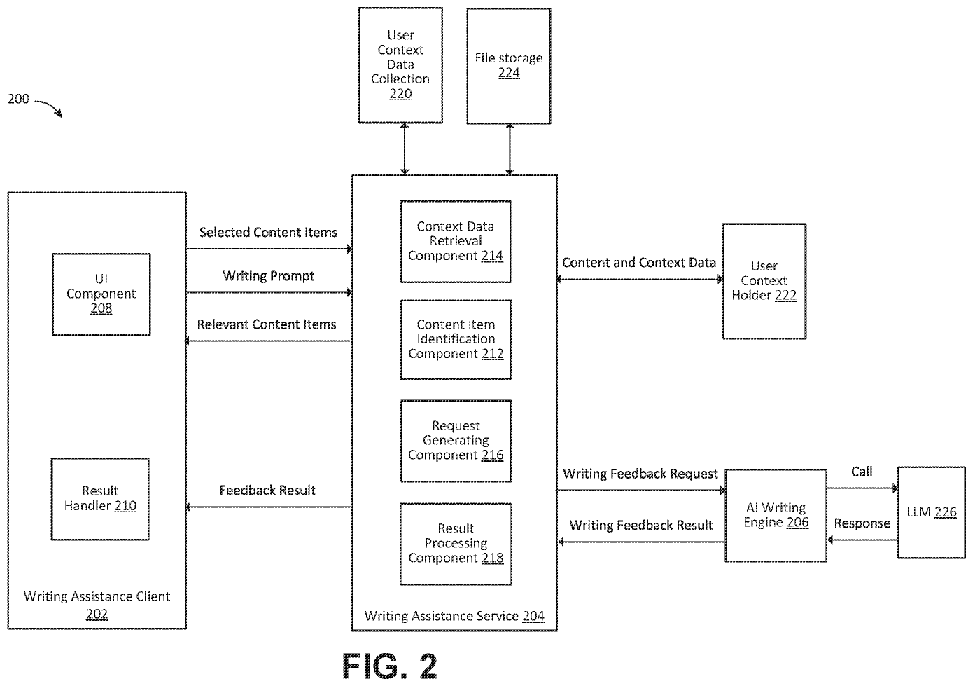

An example implementation of a writing assistance system 200 is shown in FIG. 2. Writing assistance system 200 includes a writing assistance client 202, writing assistance service 204, and an AI writing engine 206. Writing assistance client 202 is executed on a client device and is used to enable users of content editing applications to access writing assistance service 204. In embodiments, the writing assistance client 202 is integrated into a content editing application, e.g., as an included feature or an added plug-in. In other embodiments, the writing assistance client 202 is a standalone program that is programmed to interact with the content editing application.

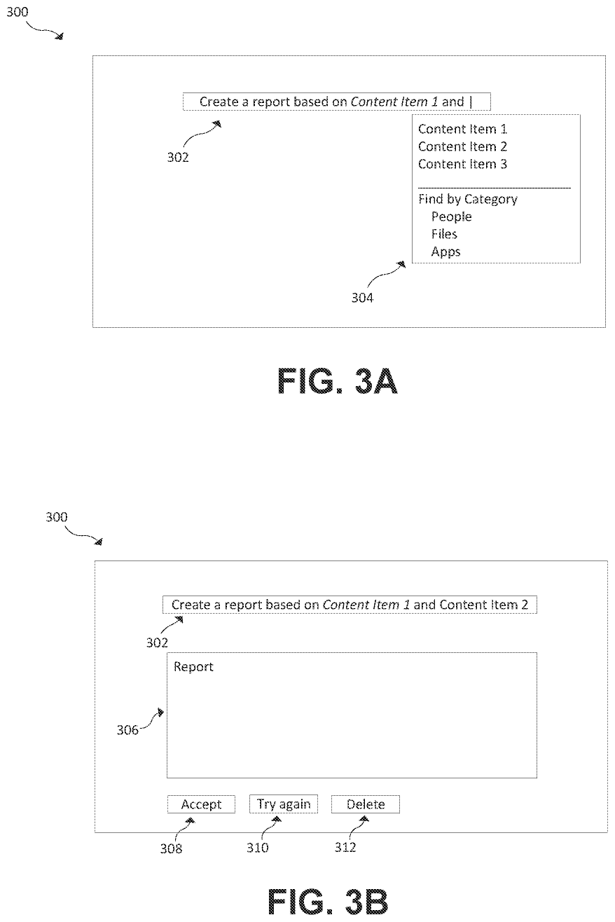

Writing assistance client 202 includes a UI component 208 and a result handler 210. An example implementation of a UI component 300 of a writing assistance client is shown in FIG. 3. In embodiments, the UI component 300 is implemented as a pop-up window which is activated from within a content editing application. The content editing application includes one or more UI controls that enable the UI component of the writing assistance client to be activated and displayed on the client device. In embodiments, UI controls for activating the UI component of the writing assistance client include buttons and/or user selectable options within one or more menus of the content editing application. In some embodiments, the UI component 300 is activated in response to receiving a predetermined keystroke or combination of keystrokes. As one example, the UI component 300 of the writing assistance client is activated by typing the “@” character into the canvas area of the content editing application.

The UI component 300 includes a text input field 302 for receiving the text for a writing prompt from a user via a user input device, such as a keyboard, touch input, voice input, etc. In embodiments, the writing prompt includes one or more references to content items which are relevant to the writing prompt. Content items can include files, documents, mail messages, social media posts, and the like that are relevant to the user and to the text being entered for the writing prompt. One example of a writing prompt which may be entered by a user includes “create a summary of information in file1.” Another example of a writing prompt is “create a report of the information included in file1 and file2.”

The UI component also includes a content item display element 304 for displaying a list of relevant content items, such as files, mail messages, social media posts, and the like. In the embodiment of FIG. 3, the content item display element 304 comprises a pop-up window or menu that appears near cursor in the text input field 302. As a user enters the text of a writing prompt, the writing assistance client sends the text to the writing assistance service which identifies relevant content items for the user based on the text (explained in more detail below) and returns the relevant content items to the writing assistance client for display in the content item display region. The content item display element 304 enables content items to be selected. e.g., by clicking on desired content items in the list. Once a content item has been selected, the writing assistance client inserts a link to the content item into the input field in line with other text (e.g., where the cursor is located). In embodiments, the UI component also includes functionality that enables content items to be searched/filtered based on category, keywords, and the like.

Once the UI component is activated, all text and links entered into the input field 302 (e.g., text and content item links) are collected until a sequence termination command is received. The sequence termination command is generated in response to activation of a UI control or in response to receiving a predetermined keystroke or combination of keystrokes, such as hitting a TAB or Enter key on a keyboard. The writing assistance client monitors user input to the UI component for the sequence termination command. Once the sequence termination command is received, the writing assistance client sends the writing prompt, including content links (if any), to the writing assistance service.

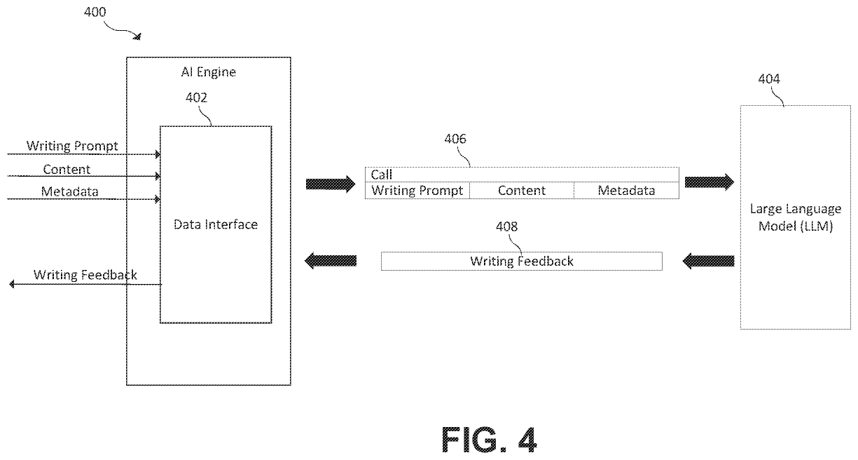

Writing assistance feedback received from the writing assistance service is provided to the result handler 210. FIG. 4 shows an example implementation of the UI component 300 showing the feedback result rendered in a result display region 306 of the UI component 300. In embodiments, the UI component includes UI controls, such as buttons 308, 310, 312, for enabling a user to accept, try again, and delete, respectively, the feedback result. In response to acceptance of the feedback result, the feedback result is transferred into the content editing application.

Returning to FIG. 2, writing assistance service 204 includes a content item identification component 212, a context data retrieval component 214, a request generating component 216, and a result processing component 218. Content item identification component 212 receives the text of a writing prompt as the text is being entered into the UI component 208 and processes the text to identify relevant content items, such as files (e.g. research papers, web pages, and other documents of various types and formats) and other data (e.g., mail messages, social media posts, and the like) having content that may be relevant to the user. In embodiments, content item identification component processes the text to identify key words, such as names, places, events, dates, and the like and uses the key words to identify relevant user content. To this end, writing assistance service has access to a user context data collection 220.

User context data collection 220 includes information identifying content items which a user has interacted with as well as metadata describing the content item and/or the interaction with the content item. In embodiments, metadata includes usage metadata which describes the interactions with a content item, such as number of times a content item was accessed/viewed/edited, actions performed with the content item, and the like. In embodiments, metadata also includes identification information for content items that enables content items to be searched, filtered, and identified, such as project name(s) associated with content items, project dates, project personnel, project key words, etc. In embodiments, user context data is stored in a user graph where each node in the graph corresponds to a different content item (e.g., tile, document, email, calendar entry, note, chat log, etc.) and each node includes metadata pertaining to the content item of that node. User context data pertaining to a user's interactions with content items is collected over time and stored in a data store by one or both of the application service and the writing assistance service.

Content item identification component 212 is configured to access the user context data collection 220 and to search user context data using key words from the writing prompt to identify relevant content items to offer to the user. Recently viewed and/or edited content items can also be offered as relevant content items. Once a content item has been identified, identification information for the content item, such as file name and file identifier, is returned to writing assistance client 202 for display in the UI component. Additional content items can be identified and returned as more text is entered for the writing prompt.

Context data retrieval component 214 is used to retrieve context data pertaining to selected content items included in a writing prompt. Each time a content item is selected to be referenced in a writing prompt (e.g., by clicking on the content item in the UI), an acceptance event is triggered which causes the context data retrieval component 214 to retrieve the content (and structure) of the accepted content item and the metadata for the accepted content item and store the content and metadata in a user context holder 222. In embodiments, content of selected content items can be retrieved from a file storage 224 maintained, for example, by the client device and/or an application service, content store 224. Context data, such as content item metadata, is retrieved from user context data collection 220. User context holder 222 is implemented by a suitable memory which is accessible to the writing assistance service 204. User context holder 222 stores content and metadata for all content items referenced in the current writing prompt. In embodiments, user context holder 222 is cleared after each writing prompt has been processed. Alternatively, the user can specify whether to maintain the current context data for subsequent writing prompts.

Once the sequence termination command is received, the writing assistance client 204 sends the writing prompt, including content links (if any), to the request generating component of the writing assistance service 204. The request generating component 216 retrieves the context data for the content items linked in the writing prompt from the user context holder 222 and generates a call to AI writing engine 206 that includes the writing prompt text and the context data (e.g., content, structure, and metadata). AI writing engine 206 communicates with an LLM 226. In embodiments, the LLM 226 is hosted remotely. e.g., on a server, and accessed via a network. AI writing engine 206 receives the context data. i.e., the writing prompt, content and metadata, and provides the context data to the LLM 226 in an appropriate format.

Referring to FIG. 4, an example implementation of an AI writing engine 400 is shown in greater detail. The AI writing engine includes a data interface 402 for receiving aggregated context data and for communicating the aggregated context data to an LLM 404. The data interface 402 receives the aggregated context data, i.e., writing prompt, content, and metadata, pertaining to a writing assistance task and uses the contexts data in a call 406 to the LLM 404. e.g., by formatting the context data for the LLM 404. In embodiments, context data can be provided to the LLM 404 in natural language or any other suitable format depending on the type of model. Calls to the LLM 404 can also be structured to include metadata pertaining to the content items included in the writing prompt. Once the call 406 is properly formatted/structured, the call 406 is submitted to the LLM 404 to obtain writing feedback 408 which is returned to the data interface 402. The data interface 402 processes the writing feedback 408 by converting the writing feedback to an appropriate format for communication to and utilization by the writing assistance service. Referring to FIG. 2, the writing feedback result is communicated to the result processing component 218. The result processing component 218 then processes the feedback result to enable communication and utilization by the result handler 210. In embodiments, the result processing component generates a document, such as a word processing document, from the writing result and transfers the document to the result handler 210.

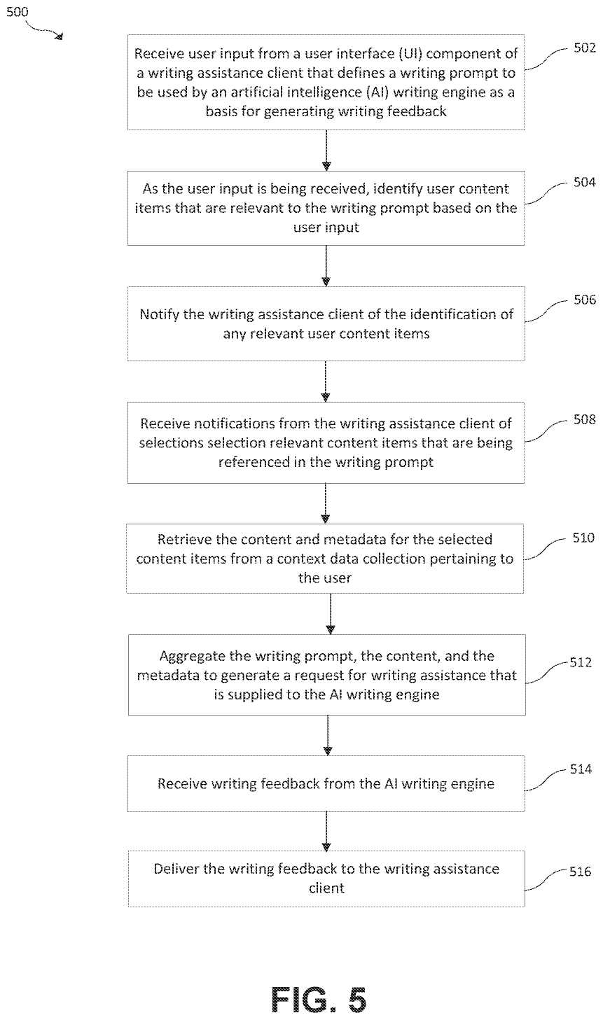

FIG. 5 is a flow diagram depicting an example method 400 for generating writing assistance from an AI writing engine. The method includes receiving user input from a user interface (UI) component of a writing assistance client that defines a writing prompt to be used by an artificial intelligence (AI) writing engine as a basis for generating writing feedback (block 502). As the user input is being received, user content items that are relevant to the writing prompt are identified based on the user input (block 504). The writing assistance client is notified of the identification of any relevant user content items (block 506). Notifications are received from the writing assistance client of selections selection relevant content items that are being referenced in the writing prompt (block 508). The content and metadata for the selected content items are retrieved from a context data collection pertaining to the user (block 510). The writing prompt, the content, and the metadata are then aggregated to generate a request for writing assistance that is supplied to the AI writing engine (block 512). The writing feedback is received from the AI writing engine (block 514). The writing feedback is then delivered to the writing assistance client (block 516).

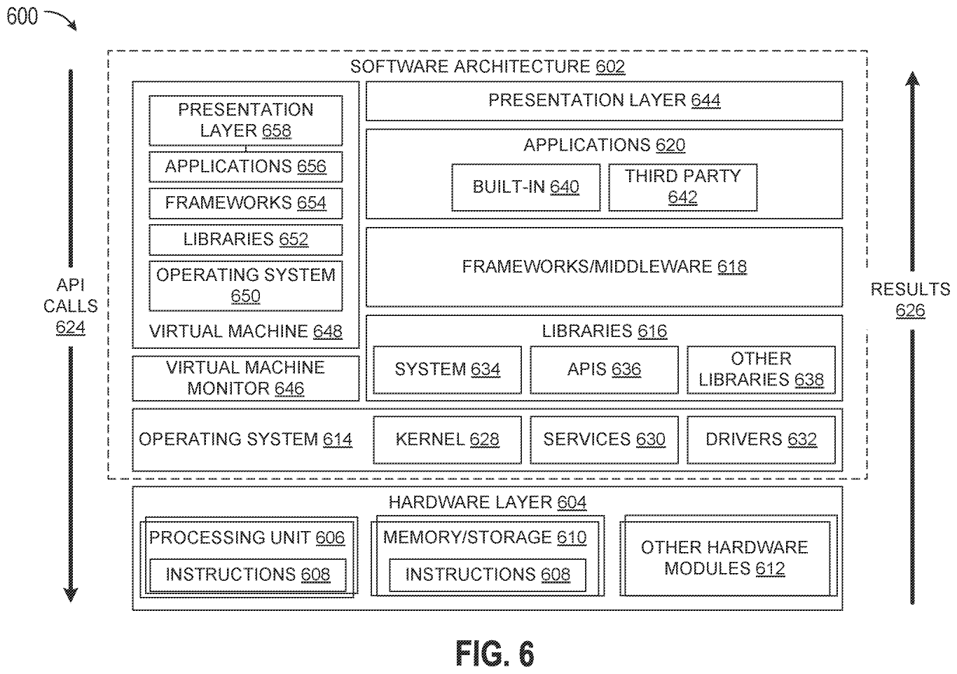

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as client devices, native application provider, web servers, server clusters, external services, and other servers. A representative hardware layer 604 includes a processing unit 606 and associated executable instructions 608. The executable instructions 608 represent executable instructions of the software architecture 602, including implementation of the methods, modules and so forth described herein.

The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular system. The applications 620 may use functions available via OS 614, libraries 616, frameworks 618, and presentation layer 644 to create user interfaces to interact with users.

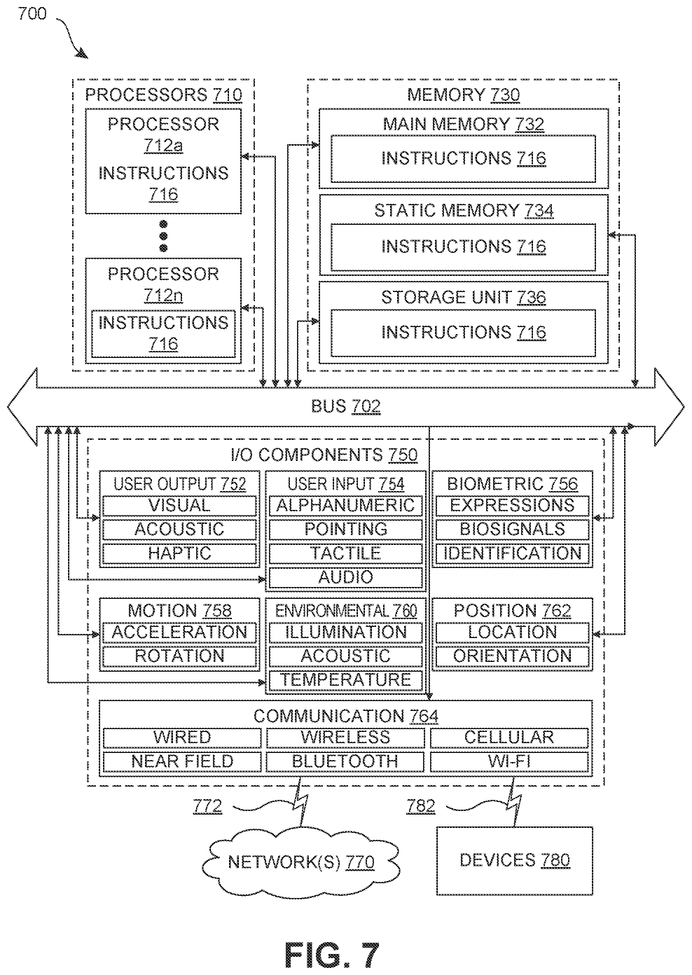

Some software architectures use virtual machines, as illustrated by a virtual machine 648. The virtual machine 648 provides an execution environment where applications/modules can execute as if they were executing on a hardware machine (such as the machine depicted in block diagram 700 of FIG. 7, for example). The virtual machine 648 may be hosted by a host OS (for example, OS 714) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 852, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement methods or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and 1/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 934, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 952 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 960 and/or position components 762, among a wide array of other environmental sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 762 may include, for example, location sensors (for example, a Global Position System (GPS) receiver), altitude sensors (for example, an air pressure sensor from which altitude may be derived), and/or orientation sensors (for example, magnetometers). The motion components 758 may include, for example, motion sensors such as acceleration and rotation sensors. The environmental components 760 may include, for example, illumination sensors, acoustic sensors and/or temperature sensors.

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication. Near Field Communication (NFC), Bluetooth communication. Wi-Fi. and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 762, such as, but not limited to, geo-location via Internet Protocol (IP) address, location via Wi-Fi, cellular. NFC. Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-8) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations. e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:

Item 1. A data processing system comprising:
a processor, and
a memory in communication with the processor, the memory comprising executable instructions that, when executed by the processor, cause the data processing system to perform functions of:
receiving user input from a user interface (UI) component of a writing assistance client, the user input defining a writing prompt to be used by an artificial intelligence (AI) writing engine as a basis for generating writing feedback;
as the user input is being received, identifying user content items relevant to the writing prompt based on the user input;
providing indication of the identified user content items to the writing assistance client;
receiving indication of selection of at least one user content item that is to be referenced in the writing prompt;
retrieving content and metadata pertaining to each selected user content item from a context data collection;
monitoring the user input for a sequence termination character;
in response to detecting the sequence termination character, aggregating the writing prompt, the content, and the metadata to generate a request for writing assistance that is supplied to the AI writing engine;
receiving the writing feedback from the AI writing engine; and
providing the writing feedback to the writing assistance client.
   Item 2. The data processing system of item 1, wherein the AI writing engine communicates the writing prompt, the content, and the metadata to a large language model (LLM) and receives the writing feedback from the LLM.
   Item 3. The data processing system of any of items 1-2, wherein identifying the user content items, further comprises:
processing the user input to identify key words pertaining to the writing prompt and identifying user content items relevant to the writing prompt based on the key words; and
identifying the user content items relevant to the writing prompt based on the key words.
   Item 4. The data processing system of any of items 1-3, wherein the user content items are identified by searching a user context data collection using the key words.
   Item 5. The data processing system of any of items 1-4, wherein the user context data collection includes information pertaining to content items the user has interacted with and metadata pertaining to the user's interactions with the content items, and
wherein the user context data is collected over time and stored by an application service.
   Item 6. The data processing system of any of items 1-5, wherein the function further comprise:
storing the retrieved content and metadata in a user context holder implemented in the memory; and
wherein, in response to detecting the sequence termination character, the content and the metadata for the content items referenced in the writing prompt is retrieved from the user context holder.
   Item 7. The data processing system of any of items 1-6, wherein the user context holder is cleared before each writing prompt is received.
   Item 8. A method for generating writing assistance from an AI writing engine, the method comprising:
receiving user input from a user interface (UI) component of a writing assistance client, the user input defining a writing prompt to be used by an artificial intelligence (AI) writing engine as a basis for generating writing feedback;
as the user input is being received, identifying user content items relevant to the writing prompt based on the user input;
providing indication of the identified user content items to the writing assistance client;
receiving indication of selection of one or more content items that are to be referenced in the writing prompt;
retrieving content and metadata pertaining to the one or more content items from a context data collection;
aggregating the writing prompt, the content, and the metadata to generate a request for writing assistance that is supplied to the AI writing engine;
receiving the writing feedback from the AI writing engine; and
providing the writing feedback to the writing assistance client.
   Item 9. The method of item 8, wherein the AI writing engine communicates the writing prompt, the content, and the metadata to a large language model (LLM) and receives the writing feedback from the LLM.
   Item 10. The method of any of items 8-9, wherein identifying the user content items, further comprises:
processing the user input to identify key words pertaining to the writing prompt and identifying user content items relevant to the writing prompt based on the key words; and
identifying the user content items relevant to the writing prompt based on the key words.
   Item 11. The method of any of items 8-10, wherein the user content items are identified by searching a user context data collection using the key words.
   Item 12. The method of any of items 8-11, wherein the user context data collection includes information pertaining to content items the user has interacted with and metadata pertaining to the user's interactions with the content items, and
wherein the user context data is collected over time and stored by an application service.
   Item 13. The method of any of items 8-12, further comprising:
storing the retrieved content and metadata in a user context holder implemented in the memory; and
wherein, in response to detecting the sequence termination character, the content and the metadata for the content items referenced in the writing prompt is retrieved from the user context holder.
   Item 14. The method of any of items 8-13, wherein the user context holder is cleared before each writing prompt is received.
   Item 15. The method of any of items 8-14, further comprising:
monitoring the user input for a sequence termination character,
wherein, the writing prompt, the content, and the metadata are aggregated to generate the request for writing assistance in response to receiving the sequence termination character.
   Item 16. A computer readable medium on which are stored instructions that, when executed, cause a programmable device to perform functions of:
receiving a writing prompt to be used by an artificial intelligence (AI) writing engine as a basis for generating writing feedback from a user interface (UI) component of a writing assistance client;
as the writing prompt is being received, identifying user content items relevant to the writing prompt based on text of the writing prompt;
providing indication of the identified user content items to the writing assistance client;
receiving indication of selection of one or more content items that are to be referenced in the writing prompt;
in response to receiving the indication, retrieving content and metadata pertaining to the one or more content items from a context data collection and storing the content and the metadata in a user context holder;
monitoring the writing prompt for a sequence termination character;
in response to detecting the sequence termination character:
   retrieving the content and the metadata from the user context holder; and
   aggregating the writing prompt, the content and the metadata to generate a request for writing assistance for the AI writing engine;
receiving the writing feedback from the AI writing engine; and
providing the writing feedback to the writing assistance client.
   Item 17. The computer readable medium of item 16, wherein the AI writing engine communicates the writing prompt, the content, and the metadata to a large language model (LLM) and receives the writing feedback from the LLM.
   Item 18. The computer readable medium of any of items 16-17, wherein the user content items are identified by searching a user context data collection using the writing prompt.
   Item 19. The computer readable medium of any of items 16-18, wherein the user context data collection includes information pertaining to content items the user has interacted with and metadata pertaining to the user's interactions with the content items.
   Item 20. The computer readable medium of any of items 16-19, wherein the user context holder is cleared before each writing prompt is received.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A data processing system comprising:
a processor; and
a memory in communication with the processor, the memory comprising executable instructions that, when executed by the processor, cause the data processing system to perform functions of:
receiving user input from a user interface (UI) component of a writing assistance client, the user input defining a writing prompt to be used by an artificial intelligence (AI) writing engine as a basis for generating writing feedback;
as the user input is being received, identifying user content items relevant to the writing prompt based on the user input the user content items being one or more files or documents that include text and which are not generated by the AI writing engine;
displaying user content items in the UI component of the writing assistance client;
receiving user input selecting at least one of the user content item to reference in the writing prompt;
retrieving content and metadata pertaining to each selected user content item from a context data collection;
monitoring the user input for a sequence termination character;
in response to detecting the sequence termination character, aggregating the writing prompt, the content, and the metadata to generate a request for writing assistance that is supplied to the AI writing engine;
receiving the writing feedback from the AI writing engine; and
providing the writing feedback to the UI component writing assistance client.

2. The data processing system of claim 1, wherein the AI writing engine communicates the writing prompt, the content, and the metadata to a large language model (LLM) and receives the writing feedback from the LLM.

3. The data processing system of claim 1, wherein identifying the user content items, further comprises:
processing the user input to identify key words pertaining to the writing prompt and identifying user content items relevant to the writing prompt based on the key words; and
identifying the user content items relevant to the writing prompt based on the key words.

4. The data processing system of claim 3, wherein the user content items are identified by searching a user context data collection using the key words.

5. The data processing system of claim 4, wherein the user context data collection includes information pertaining to content items the user has interacted with and metadata pertaining to the user's interactions with the content items, and
wherein the user context data is collected over time and stored by an application service.

6. The data processing system of claim 1, wherein the function further comprise:
storing the retrieved content and metadata in a user context holder implemented in the memory; and
wherein, in response to detecting the sequence termination character, the content and the metadata for the content items referenced in the writing prompt is retrieved from the user context holder.

7. The data processing system of claim 6, wherein the user context holder is cleared before each writing prompt is received.

8. A method for generating writing assistance from an AI writing engine, the method comprising:
receiving user input from a user interface (UI) component of a writing assistance client, the user input defining a writing prompt to be used by an artificial intelligence (AI) writing engine as a basis for generating writing feedback;
as the user input is being received, identifying user content items relevant to the writing prompt based on the user input the user content items being one or more files or documents that include text and which are not generated by the AI writing engine;
displaying the user content items in the UI component of the writing assistance client;
receiving user input selecting one or more of the content items to reference in the writing prompt;
retrieving content and metadata pertaining to the one or more selected content items from a context data collection;
aggregating the writing prompt, the content, and the metadata to generate a request for writing assistance that is supplied to the AI writing engine;
receiving the writing feedback from the AI writing engine; and
providing the writing feedback to the UI component of the writing assistance client.

9. The method of claim 8, wherein the AI writing engine communicates the writing prompt, the content, and the metadata to a large language model (LLM) and receives the writing feedback from the LLM.

10. The method of claim 8, wherein identifying the user content items, further comprises:
processing the user input to identify key words pertaining to the writing prompt and identifying user content items relevant to the writing prompt based on the key words; and
identifying the user content items relevant to the writing prompt based on the key words.

11. The method of claim 10, wherein the user content items are identified by searching a user context data collection using the key words.

12. The method of claim 11, wherein the user context data collection includes information pertaining to content items the user has interacted with and metadata pertaining to the user's interactions with the content items, and
wherein the user context data is collected over time and stored by an application service.

13. The method of claim 8, further comprising:
storing the retrieved content and metadata in a user context holder implemented in a memory; and
wherein, in response to detecting a sequence termination character, the content and the metadata for the content items referenced in the writing prompt is retrieved from the user context holder.

14. The method of claim 13, wherein the user context holder is cleared before each writing prompt is received.

15. The method of claim 8, further comprising:
monitoring the user input for a sequence termination character,
wherein, the writing prompt, the content, and the metadata are aggregated to generate the request for writing assistance in response to receiving the sequence termination character.

16. A computer readable medium on which are stored instructions that, when executed, cause a programmable device to perform functions of:
receiving a writing prompt to be used by an artificial intelligence (AI) writing engine as a basis for generating writing feedback from a user interface (UI) component of a writing assistance client;
as the writing prompt is being received, identifying user content items relevant to the writing prompt based on text of the writing prompt the user content items being one or more files or documents that include text and which are not generated by the AI writing engine;
displaying the user content items in the UI component gf the writing assistance client;
receiving user input selecting one or more of the content items to reference in the writing prompt;
in response to receiving the user input, retrieving content and metadata pertaining to the one or more selected content items from a context data collection and storing the content and the metadata in a user context holder;
monitoring the writing prompt for a sequence termination character;
in response to detecting the sequence termination character:
retrieving the content and the metadata from the user context holder; and
aggregating the writing prompt, the content and the metadata to generate a request for writing assistance for the AI writing engine;
receiving the writing feedback from the AI writing engine; and
providing the writing feedback to the UI component writing assistance client.

17. The computer readable medium of claim 16, wherein the AI writing engine communicates the writing prompt, the content, and the metadata to a large language model (LLM) and receives the writing feedback from the LLM.

18. The computer readable medium of claim 16, wherein the user content items are identified by searching a user context data collection using the writing prompt.

19. The computer readable medium of claim 18, wherein the user context data collection includes information pertaining to content items the user has interacted with and metadata pertaining to the user's interactions with the content items.

20. The computer readable medium of claim 16, wherein the user context holder is cleared before each writing prompt is received.
